(19) United States
(12) Patent Application Publication
(10) Pub. No.: US 2014/0323604 A1
(43) Pub. Date: Oct. 30, 2014

(54) DUAL-FOAMED POLYMER COMPOSITION

(71) Applicant: tesa SE, Hamburg (DE)

(72) Inventors: Axel Burmeister, Hamburg (DE); Franziska Czerwonatis, Hamburg (DE)

(73) Assignee: tesa SE, Hamburg (DE)

(21) Appl. No.: 14/255,384

(22) Filed: Apr. 17, 2014

(30) Foreign Application Priority Data
Apr. 24, 2013 (DE) 10 2013 207 467.0

(51) Int. Cl. C08J 9/32; B29C 43/24; C09J 9/00

(52) U.S. Cl. CPC C08J 9/32; C09J 9/00; B29C 43/24
USPC 521/56; 521/149; 264/321

(57) ABSTRACT

A polymer foam having high bonding strength and improved compressive hardness characteristics is accomplished by the polymer foam comprising cavities formed by microballoons, and also 2 to 20 vol. %, based on the total volume of the polymer foam, of cavities surrounded by the polymer foam matrix.

The present invention is situated within the technical field of polymer foams, more particularly the polymer foams produced using hollow microbodies and used, for example, for assembly jobs, more particularly for adhesive bonding. The invention relates in particular to a polymer foam which comprises differently enveloped cavities.

Foamed polymer systems have been known, and described in the prior art, for some considerable time. Polymer foams may in principle be produced in two ways: first, by the action of a propellant gas, whether added as such or resulting from a chemical reaction, and secondly by the incorporation of hollow spheres into the materials matrix. Foams produced in the latter way are referred to as syntactic foams.

Compositions foamed with hollow microspheres are notable for a defined cell structure with a uniform size distribution of the foam cells. With hollow microspheres, closed-cell foams without voids are obtained, which in comparison to open-cell variants are distinguished by qualities including improved sealing with respect to dust and liquid media. Furthermore, chemically or physically foamed materials are more susceptible to irreversible collapse under pressure and temperature, and frequently exhibit a lower cohesive strength.

Particularly advantageous properties can be obtained if the hollow microspheres used for foaming are expandable hollow microspheres (also referred to as “microballoons”). By virtue of their flexible, thermoplastic polymer shell, such foams possess a greater conformability than those filled with non-expandable, non-polymeric hollow microspheres (for example hollow glass beads). They are better suited to compensation of manufacturing tolerances, such as are the general rule in injection mouldings, for example, and on the basis of their foam character they are also able to compensate thermal stresses more effectively.

Furthermore, the mechanical properties of the foam can be influenced further through the selection of the thermoplastic resin of the polymer shell. Thus, for example, it is possible to produce foams having a higher cohesive strength than with the polymer matrix alone. In this way, typical foam properties such as conformability to rough substrates can be combined with a high cohesive strength, a combination which may be of advantage, for example, when the foam is used as a pressure sensitive adhesive.

German laid-open specification 21 05 877 describes an adhesive strip coated on at least one side of its carrier with a pressure-sensitive adhesive which comprises a multiplicity of microscopic, spherical, closed cells. The empty volume of the layer of adhesive is 25% to 85%, and the cell walls are formed by the adhesive.

EP 0 257 984 A1 discloses adhesive tapes which on at least one side have a foamed adhesive coating. Contained within this adhesive coating are polymer beads which contain a fluid comprising hydrocarbons and which expand at elevated temperatures. The scaffold polymers of the self-adhesives may consist of rubbers or polyacrylates. The hollow microbeads are added either before or after the polymerization. The self-adhesives comprising microballoons are processed from solvent and shaped to form adhesive tapes. The foaming step here takes place consistently after coating. Accordingly, micro-rough surfaces are obtained. This results in properties such as, in particular, non-destructive redetachability and repositionability. The effect of the better repositionability through micro-rough surfaces of self-adhesives foamed with microballoons is also described in other specifications such as DE 35 37 433 A1 or WO 95/31225 A1. A micro-rough surface can also be used, according to EP 0 693 097 A1 and WO 98/18878 A1, to obtain bubble-free adhesive bonds.

The advantageous properties of the micro-rough surfaces are always opposed, however, by a marked reduction in the bond strength or peel strength. In DE 197 30 854 A1, therefore, a carrier layer is proposed which is foamed using microballoons and which proposes the use of unfoamed, pressure-sensitive self-adhesives above and below a foamed core.

The carrier mixture is prepared preferably in an internal mixer as typical for elastomer compounding. In a second, cold operation, the mixture is admixed with possible crosslinkers, accelerators and the desired microballoons. This second operation takes place preferably at temperatures of less than 70° C. in a kneading apparatus, internal mixer, on mixing rolls or in a twin-screw extruder. The mixture is subsequently mechanically extruded and/or calendered to the desired thickness. Thereafter the carrier is provided on both sides with a pressure-sensitive self-adhesive.

To avoid damage to the microballoons from the forces which act during balloon incorporation, the foaming is carried out preferably after sheet shaping, in a heating tunnel. In this operation it is easy for very severe deviations in the average carrier thickness from the desired thickness to occur, in particular as a result of inconsistent processing conditions before and/or during foaming. Targeted correction to the thickness is no longer possible. It is also necessary to accept considerable statistical deviations in the thickness, since local deviations in the microballoon concentration and in the concentration of other carrier constituents are manifested directly in fluctuations in thickness.

A similar path is described by WO 95/32851 A1. There it is proposed that additional thermoplastic layers be provided between foamed carrier and self-adhesive.

Both pathways, while fulfilling the requirement of a high peel strength, nevertheless lead overall to products with marked mechanical susceptibility, because the individual layers tend under loading to develop breaks in anchoring. Furthermore, the desired conformability of such products to different surface types is significantly restricted, because the foamed fraction of the system is inevitably reduced.

EP 1 102 809 A1 proposes a method in which the microballoons expand at least partly even before emergence from a coating nozzle and are brought optionally to complete expansion by a downstream step. This method leads to products having significantly lower surface roughness and a concomitant smaller drop in peel strength.

JP 2006 022189 describes a viscoelastic composition which features a blister structure and spherical hollow microbodies, and also a pressure-sensitive adhesive tape or a pressure-sensitive adhesive sheet, for which the viscoelastic composition is used. The air bubbles are incorporated by mixing into a syrup-like polymer composition. On account of the low viscosity, the bubbles flow together and form larger air bubbles, whose size and distribution are uncontrollable.

An ongoing need exists for foams, produced with the aid of hollow microbodies, which have the advantageous properties resulting from this technology and with which disadvantageous properties are avoided or at least reduced.

It is an object of the invention, therefore, to provide a stable polymer foam, produced with the aid of hollow microbodies, with a very high degree of uniformity in the size distribution of the foam cells, and distinguished in particular by high bonding strength and good compression hardness characteristics.

The achievement of this object is based on the concept of incorporating into the foam a defined fraction of cavities surrounded by the foam matrix. The invention first provides, accordingly, a polymer foam which comprises cavities formed by microballoons and also 2 to 20 vol %, based on the total volume of the polymer foam, of cavities surrounded by the polymer foam matrix. A foam of this kind, relative to a foam whose cavities are formed exclusively by hollow microbodies, exhibits an increased bonding strength, as manifested in cohesive fracture patterns in corresponding tests. Furthermore, a foam of the invention can be more easily compressed and exhibits an improved resilience.

A “polymer foam” is a material having open and/or closed cells distributed throughout its mass, and having an unadjusted density which is lower than that of the scaffold substance. The scaffold substance, also referred to hereinafter as polymer foam matrix, foam matrix, matrix, or matrix material, comprises, in accordance with the invention, one or more polymers, which may have been blended with adjuvants.

The polymer foam of the invention preferably comprises at least 25 wt %, based on the total weight of the polymer foam, of one or more polymers selected from the group consisting of polyacrylates, natural rubbers and synthetic rubbers. Generally speaking, hybrid systems of adhesives with different bases may also be present—thus, for example, blends based on two or more of the following classes of chemical compound: natural rubbers and synthetic rubbers, polyacrylates, polyurethanes, silicon rubbers, polyolefins. Copolymers of monomers from the above polymer classes and/or further monomers can also be used in accordance with the invention.

The natural rubbers which can be used in accordance with the invention may be selected in principle from all available grades, such as, for example, crepe, RSS, ADS, TSR or CV grades, according to the required level of purity and of viscosity. The synthetic rubbers which can be used in accordance with the invention are selected preferably from the group of randomly copolymerized styrene-butadiene rubbers (SBR), butadiene rubbers (BR), synthetic polyisoprenes (IR), butyl rubbers (IIR), halogenated butyl rubbers (XIIR), acrylate rubbers (ACM), ethylene-vinyl acetate copolymers (EVA) and polyurethanes and/or blends thereof. Furthermore, the synthetic rubbers may also include thermoplastic elastomers, examples being styrene block copolymers such as, in particular, styrene-isoprene-styrene (SIS) and styrene-butadiene-styrene (SBS) types. It is also possible for any desired blends of different natural rubbers or of different synthetic rubbers, or of different natural rubbers and synthetic rubbers, to be used.

The polymer foam of the invention may also comprise polymers from the group of the polyacrylates. It is advantageous here for at least some of the parent monomers to have functional groups which are able to react in a thermal crosslinking reaction and/or which promote a thermal crosslinking reaction.

Preferably in accordance with the invention the polymer foam comprises at least 25 wt %, based on the total weight of the polymer foam, of a polyacrylate which can be attributed to the following monomer composition:
a) acrylic esters and/or methacrylic esters of the following formula

CH₂═C(R^{I})(COOR^{II}),
where R^{I}═H or CH₃ and R^{II} is an alkyl radical having 4 to 14 C atoms,
b) olefinically unsaturated monomers having functional groups which exhibit reactivity with the crosslinker substances or with some of the crosslinker substances,
c) optionally further acrylates and/or methacrylates and/or olefinically unsaturated monomers, which are copolymerizable with component (a).

For preferred application of the polymer foam as pressure sensitive adhesive, the fractions of the corresponding components (a), (b) and (c) are selected more particularly such that the polymerization product has a glass transition temperature ≦15° C. (DMA at low frequencies). For this purpose it is advantageous to select the monomers of component (a) with a fraction of 45 to 99 wt %, the monomers of component (b) with a fraction of 1 to 15 wt % and the monomers of component (c) with a fraction of 0 to 40 wt %, the figures being based on the monomer mixture for the “basic polymer”, i.e. without additions of possible additives to the completed polymer, such as resins, etc.

For application of the polymer foam as a hotmelt adhesive, in other words as a material which develops pressure-sensitive tack only on heating, the fractions of the corresponding components (a), (b) and (c) are selected more particularly such that the copolymer has a glass transition temperature (T_{g}) of between 15° C. and 100° C., more preferably between 30° C. and 80° C. and very preferably between 40° C. and 60° C.

A viscoelastic polymer foam which may for example be laminated on both sides with pressure-sensitively adhesive layers preferably has a glass transition temperature (T_{g}) of between −50° C. and +100° C., more preferably between −20° C. and +60° C., more particularly between 0° C. and 40° C. Here again, the fractions of components (a), (b) and (c) may be selected accordingly.

The monomers of component (a) are, in particular, plasticizing monomers and/or apolar monomers.

For the monomers (a), preference is given to using acrylic monomers, which comprise acrylic and methacrylic esters with alkyl groups containing 4 to 14 C atoms, preferably 4 to 9 C atoms. Examples of such monomers are n-butyl acrylate, n-butyl methacrylate, n-pentyl acrylate, n-pentyl methacrylate, n-amyl acrylate, n-hexyl acrylate, hexyl methacrylate, n-heptyl acrylate, n-octyl acrylate, n-octyl methacrylate, n-nonyl acrylate, isobutyl acrylate, isooctyl acrylate, isooctyl methacrylate, and their branched isomers, such as 2-ethylhexyl acrylate and 2-ethylhexyl methacrylate, for example.

The monomers of component (b) are, in particular, olefinically unsaturated monomers having functional groups which are able to enter into a reaction with epoxide groups. For component (b), therefore, preference is given to using monomers having functional groups selected from the following group: hydroxyl, carboxyl, sulfonic acid and phosphonic acid groups, acid anhydrides, epoxides, amines.

Particularly preferred examples of monomers of component (b) are acrylic acid, methacrylic acid, itaconic acid, maleic acid, fumaric acid, crotonic acid, aconitic acid, dimethylacrylic acid, β-acryloyloxy propionic acid, trichloroacrylic acid, vinylacetic acid, vinylphosphonic acid, itaconic acid, maleic anhydride, hydroxyethyl acrylate, hydroxypropyl acrylate, hydroxyethyl methacrylate, hydroxypropyl methacrylate, 6-hydroxyhexyl methacrylate, allyl alcohol, glycidyl acrylate and glycidyl methacrylate.

For the polyacrylates of component (c) it is possible in principle to use all vinylically functionalized compounds which are copolymerizable with component (a) and/or component (b). These monomers preferably also serve for adjusting the properties of the resultant polymer foam.

Examples that may be listed are the following monomers for component (c):

methyl acrylate, ethyl acrylate, propyl acrylate, methyl methacrylate, ethyl methacrylate, benzyl acrylate, benzyl methacrylate, sec-butyl acrylate, tert-butyl acrylate, phenyl acrylate, phenyl methacrylate, isobornyl acrylate, isobornyl methacrylate, tert-butylphenyl acrylate, tert-butylphenyl methacrylate, dodecyl methacrylate, isodecyl acrylate, lauryl acrylate, n-undecyl acrylate, stearyl acrylate, tridecyl acrylate, behenyl acrylate, cyclohexyl methacrylate, cyclopentyl methacrylate, phenoxyethyl acrylate, phenoxyethyl methacrylate, 2-butoxyethyl methacrylate, 2-butoxyethyl acrylate, 3,3,5-trimethylcyclohexyl acrylate, 3,5-dimethyladamantyl acrylate, 4-cumylphenyl methacrylate, cyanoethyl acrylate, cyanoethyl methacrylate, 4-biphenylyl acrylate, 4-biphenylyl methacrylate, 2-naphthyl acrylate, 2-naphthyl methacrylate, tetrahydrofurfuryl acrylate, diethylaminoethyl acrylate, diethylaminoethyl methacrylate, dimethylaminoethyl acrylate, dimethylaminoethyl methacrylate, 2-butoxyethyl acrylate, 2-butoxyethyl methacrylate, methyl 3-methoxyacrylate, 3-methoxybutyl acrylate, phenoxyethyl acrylate, phenoxyethyl methacrylate, 2-phenoxyethyl methacrylate, butyl diglycol methacrylate, ethylene glycol acrylate, ethylene glycol monomethylacrylate, methoxy polyethylene glycol methacrylate 350, methoxy polyethylene glycol methacrylate 500, propylene glycol monomethacrylate, butoxydiethylene glycol methacrylate, ethoxytriethylene glycol methacrylate, octafluoropentyl acrylate, octafluoropentyl methacrylate, 2,2,2-trifluoroethyl methacrylate, 1,1,1,3,3,3-hexafluoroisopropyl acrylate, 1,1,1,3,3,3-hexafluoroisopropyl methacrylate, 2,2,3,3,3-pentafluoropropyl methacrylate, 2,2,3,4,4,4-hexafluorobutyl methacrylate, 2,2,3,3,4,4,4-heptafluorobutyl acrylate, 2,2,3,3,4,4,4-heptafluorobutyl methacrylate, 2,2,3,3,4,4,5,5,6,6,7,7,8,8,8-pentadeca-fluorooctyl methacrylate, dimethylaminopropyl acrylamide, dimethylaminopropyl methacrylamide, N-(1-methylundecyl)acrylamide, N-(n-butoxymethyl)acrylamide, N-(butoxymethyl)methacrylamide, N-(ethoxymethyl)acrylamide, N-(n-octadecyl)acrylamide, and also N,N-dialkyl-substituted amides, such as, for example, N,N-dimethylacrylamide, N,N-dimethylmethacrylamide, N-benzylacrylamides, N-isopropylacrylamide, N-tert-butylacrylamide, N-tert-octylacrylamide, N-methylolacrylamide, N-methylolmethacrylamide, acrylonitrile, methacrylonitrile, vinyl ethers, such as vinyl methyl ether, ethyl vinyl ether and vinyl isobutyl ether, vinyl esters, such as vinyl acetate, vinyl chloride, vinyl halogenides, vinylidene chloride, vinylidene halides, vinylpyridine, 4-vinylpyridine, N-vinylphthalimide, N-vinyllactam, N-vinylpyrrolidone, styrene, α- and p-methylstyrene, α-butylstyrene, 4-n-butylstyrene, 4-n-decylstyrene, 3,4-dimethoxystyrene, and also macromonomers such as 2-polystyrene-ethyl methacrylate (molecular weight Mw from 4000 to 13 000 g/mol) and poly(methyl methacrylate)ethyl methacrylate (Mw from 2000 to 8000 g/mol).

Monomers of component (c) may advantageously also be selected such that they contain functional groups which support subsequent radiation crosslinking (by means, for example, of electron beams, UV). Examples of suitable copolymerizable photoinitiators include benzoin acrylate and acrylate-functionalized benzophenone derivates. Monomers which support crosslinking by electron beam bombardment are, for example, tetrahydrofurfuryl acrylate, N-tert-butylacrylamide and allyl acrylate.

The polymer foam of the invention comprises cavities formed by microballoons. “Microballoons” are hollow microspheres with a thermoplastic polymer shell that are elastic and hence in their basic state can be expanded. These spheres are filled with low-boiling liquids or liquefied gas. Finding particular use as shell material are polyacrylonitrile, PVDC, PVC or polyacrylates. Suitable low-boiling liquids, in particular, are hydrocarbons of the lower alkanes, such as isobutane or isopentane, which are enclosed in the polymer shell in the form of liquefied gas under pressure.

Action on the microballoons, more particularly heating, causes softening of the outer polymer shell. At the same time, the liquid propellant gas within the shell transitions to its gaseous state. This is accompanied by irreversible, three-dimensional expansion of the microballoons. Expansion is at an end when the internal and external pressures become matched. Since the polymeric shell is retained, the result is a closed-cell foam.

A multiplicity of types of microballoon are available commercially, and differ essentially in their size (6 to 45 μm diameter in the unexpanded state) and in the onset temperature they require for their expansion (75 to 220° C.). An example of commercially available microballoons are the Expancel® DU products (DU=dry unexpanded) from Akzo Nobel. If the type of microballoon or the foaming temperature is matched to the machine parameters and the temperature profile that is required for compounding of the composition, such compounding and foaming may also take place at one and the same time, in a single step.

Unexpanded microballoon types are also available in the form of an aqueous dispersion with a solids fraction or microballoon fraction of around 40 to 45 wt % and also as polymer-bound microballoons (masterbatches), for example in ethylene-vinyl acetate, with a microballoon concentration of about 65 wt %. Not only the microballoon dispersions but also the masterbatches are suitable, like the DU products, for producing polymer foams of the invention.

Polymer foams of the invention may also be produced using pre-expanded microballoons. With this group, expansion takes place even before incorporation into the polymer matrix by mixing. Pre-expanded microballoons are available commercially, for example, under the Dualite® name or with the type designation DE (Dry Expanded).

With preference in accordance with the invention, at least 90% of all of the cavities formed by microballoons have a maximum diameter of 10 to 500 μm, more preferably of 15 to 200 μm. The “maximum diameter” refers to the maximum extent of a microballoon in any three-dimensional direction.

It has been found in tests that the attainable microballoon diameter is very heavily dependent on the polymer and process used. For the process selection it has proved to be advantageous, in order to obtain microballoons with maximum expansion, to expose the microballoons at above the foaming onset temperature to a pressure below atmospheric pressure. While this does involve the destruction of a small number of very large microballoons, the great majority of the microballoons nevertheless undergo complete expansion. In this way, highly stable syntactic foams are obtainable which have an extremely small diameter distribution. The maximum attainable average diameters increase with decreasing cohesion of the surrounding polymer at the foaming temperature. With particular preference, the microballoons and polymers which can be used in accordance with the invention produce average diameters of 25 to 40 μm, with the scatter in the average values from the individual measurements not deviating by more than 2 μm from the total average value for a sample.

The diameters are determined on the basis of a cryofracture edge under a scanning electron microscope (SEM) at 500× magnification. The diameter is determined graphically for each individual microballoon. The average value of an individual measurement is a product of the average value of the diameters of all microballoons in a cryofracture; the overall average comes from the average value over 5 single measurements. The individual microballoons in the syntactic foams, according to this process, also exhibit a very narrow size distribution, with generally more than 95% of all the microballoons being smaller than twice the average value.

The polymer foam of the invention further comprises 2 to 20 vol %, based on the total volume of the polymer foam, of cavities enclosed by the polymer foam matrix. The expression “enclosed” is understood in accordance with the invention to mean complete surrounding of the corresponding cavities. “Enclosed by the polymer foam matrix” means that the gas of the respective cavity is surrounded directly by the matrix material of the foam, while the material directly surrounding the cavity, in the case of the cavities formed by microballoons, is the shell material of the microballoons. A polymer foam of the invention therefore comprises both cavities with their own shell and cavities without their own shell, the expression “own shell” referring to a material different from the polymer foam matrix. This duality of the foam cells is essential for the outstanding properties of the foam of the invention.

The cavities enclosed by the polymer foam matrix preferably contain air. This air results from the method, presented later in this text, for the production of a foam of the invention.

A polymer foam of the invention preferably comprises 3 to 18 vol %, more preferably 6 to 16 vol %, more particularly 9 to 15.8 vol %, for example 10 to 15.5 vol %, based in each case on the total volume of the polymer foam, of cavities which are enclosed by the polymer foam matrix. With these preferred volume fractions, in particular, the highest bonding strengths are achieved, which is very important for one preferred use of the polymer foam as pressure sensitive adhesive.

The volume ratio of the cavities formed by microballoons to the cavities enclosed by the polymer foam matrix is preferably from 0.5 to 10, more preferably from 0.6 to 6, more particularly from 0.7 to 4, and very preferably from 1 to 3, for example from 2 to 2.6.

At least 90% of all the cavities enclosed by the polymer foam matrix preferably have a maximum diameter of ≦200 μm. The “maximum diameter” refers to the greatest extent of the respective cavity in any three-dimensional direction. Cavities or bubbles with the preferred diameter display less of a tendency to flow together, with the associated formation of larger bubbles. This is advantageous for the homogeneity of the profile of properties over the whole of the foam.

The diameters are determined—as already described above for the hollow microspheres—on the basis of a cryofracture edge under a scanning electron microscope (SEM) at 500× magnification. The maximum diameter is determined graphically for each individual cavity. The average value of an individual measurement is a product of the average value of the diameters of all cavities in a cryofracture; the overall average comes from the average value over 5 single measurements.

With preference in accordance with the invention, the polymer foam is a pressure sensitive adhesive. In this case, in particular, the higher attainable bond strength and the higher bonding strength of the adhesive bonds produced using the foam are very advantageous. Pressure sensitive adhesives or self-adhesives are adhesives which are permanently tacky at room temperature. Self-adhesive products (that is, products furnished with self-adhesives, such as self-adhesive tapes and the like) display viscoelastic properties and bond to the majority of surfaces on application even of gentle pressure. Activation by moistening or warming is not required.

The composition system and/or the composition of the foam may further be selected such that the polymer foam can be used as a carrier layer, more particularly for a single-sided or double-sided adhesive tape. For this purpose, a layer of the polymer foam of the invention is furnished on one or both sides with a layer of adhesive, more particularly with a layer of self-adhesive. The above comments concerning the chemical nature of the polymer foam are valid here analogously. A carrier layer of this kind need not necessarily have adhesive or self-adhesive properties, but of course may do so.

Foamed carrier layers can also be used for what are called “seal tapes”, by being coated on one or both sides with a polymer composition which is non-tacky or has weak tack particularly at room temperature but which is activated and becomes tacky on supply of thermal energy—that is, a heat-activatable adhesive. Only on supply of thermal energy do heat-activatable adhesives sufficiently develop the adhesive properties needed for the end application. Heat-activatable adhesives which can be used are thermoplastic heat-activatable adhesives—known as hotmelt adhesives—and/or reactive heat-activatable adhesives. Hotmelt adhesives are usually solvent-free adhesives which only under heat develop sufficient fluidity to develop forces of (self-)adhesion. Reactive heat-activatable adhesives are adhesives in which supply of heat is accompanied by a chemical reaction, causing the adhesive chemically to set, with the consequent adhesive effect.

If the seal tapes are provided on one side with a heat-activatable adhesive layer, the carrier layer itself may be of pressure-sensitive adhesive design, and so the second seal-tape side has self-adhesive properties.

The foamed layers of self-adhesive and/or foamed carrier layers offer the advantage that they can be produced within a wide thickness range. Among others, even very thick layers can be realized, which advantageously have pressure-absorbing and impact-absorbing properties and/or roughness-compensating properties. Self-adhesive tapes with one or more layers of self-adhesive foamed in this way, and/or with a carrier layer foamed in this way, are therefore especially suitable for adhesive bonding in devices with fragile components such as windows.

The polymer foam of the invention is preferably in the form of a layer in a thickness range of up to several millimetres, more preferably in the range from 20 μm to 5000 μm, more particularly from 50 μm to 3000 μm, very preferably from 400 μm to 2100 μm. A further advantage of the foamed layers of self-adhesive and/or foamed carrier layers is their outstanding low-temperature impact resistance.

The weight per unit volume (overall density) of a polymer foam of the invention is preferably in the range from 150 to 900 kg/m³, more preferably from 350 to 880 kg/m³.

Adhesive tapes produced using the polymer foam of the invention may take any of the following forms:
single-layer, double-sidedly self-adhesive tapes—known as “transfer tapes”—comprising a single layer of a foamed self-adhesive;
single-sidedly self-adhesively furnished adhesive tapes—“single-sided self-adhesive tapes” hereinafter—where the layer of self-adhesive is a layer of the polymer foam of the invention; for example, two-layer systems comprising a foamed self-adhesive and an unfoamed self-adhesive or a heat-activatable adhesive or a foamed or unfoamed carrier layer;
single-sided self-adhesive tapes in which the carrier layer is a layer of the polymer foam of the invention;
double-sidedly self-adhesively furnished adhesive tapes—“double-sided self-adhesive tapes” hereinafter—where one layer, more particularly both layers, of self-adhesive is/are a layer of the polymer foam of the invention, and/or where the carrier layer is a layer of the polymer foam of the invention;
double-sided adhesive tapes having a heat-activatable adhesive layer on one of the adhesive tape sides and a layer of self-adhesive on the other adhesive tape side, where the carrier layer and/or the layer of self-adhesive are/is a layer of the polymer foam of the invention;
double-sided adhesive tapes having a heat-activatable adhesive layer on both adhesive tape sides, where the carrier layer is a layer of the polymer foam of the invention.

The double-sided products here, irrespective of whether they are intended for adhesive bonding or for sealing, may have a symmetrical or an asymmetrical construction.

The polymers of the foam matrix are preferably at least partly crosslinked in order to improve cohesion. It is therefore advantageous to add crosslinkers and optionally accelerants and/or inhibitors (retardants) to the composition for producing the polymer foam matrix. Below, the components that are added for initiation and for control, such as crosslinkers and accelerants, are also referred to jointly as a “crosslinking system”. Suitable crosslinking methods are radiation-initiated crosslinking methods—more particularly involving actinic or ionizing radiation such as electron beams and/or ultraviolet radiation—and/or thermally initiated crosslinking methods, the latter including methods in which the activation energy can be applied even at room temperature or below without additional application of radiation, such as of actinic or ionizing radiation.

Radiation-initiated crosslinking may be achieved in particular by bombardment with electron beams and/or with UV radiation. For this purpose, corresponding radiation-activatable crosslinkers are advantageously added to the polymer composition to be crosslinked. In order to obtain a uniform surface on both sides in the case of layers, particularly in the case of carrier layers or double-sidedly adhesively furnished adhesive tapes, it is possible to adopt a procedure in which these products are irradiated on both sides under the same conditions.

In the case of crosslinking with electron beams, there are advantages to using irradiation apparatus such as linear cathode systems, scanner systems or segmented cathode systems, in each case configured as electron beam accelerators. Typical acceleration voltages are in the range between 50 kV and 500 kV, preferably between 80 kV and 300 kV. The scatter doses employed range, for example, between 5 to 150 kGy, more particularly between 20 and 100 kGy. For this purpose, the common crosslinking substances (electron beam crosslinkers) may be added to the polymer composition. Particular preference is given to irradiation with exclusion of air through inertization with nitrogen or noble gases, or through double-sided lining with release materials, such as release-furnished films.

For optional crosslinking with UV light, UV-absorbing photoinitiators may be added to the foam matrices, these initiators being more particularly compounds which form radicals as a result of UV activation. Outstandingly suitable UV photoinitiators are those compounds which on UV irradiation enter into a photofragmentation reaction, more particularly cleavage in α-position to form a photochemically excitable functional group. Photoinitiators of this kind are those of the Norrish I type. Further outstandingly suitable photoinitiators are those compounds which on UV radiation react with an intramolecular hydrogen abstraction, triggered by a photochemically excited functional group, more particularly in γ-position. Photoinitiators of this kind are counted among the Norrish II type. It may be advantageous, furthermore, to use copolymerizable photoinitiators, by endowing the polymer to be crosslinked, by copolymerization, with monomers having functional groups which can initiate crosslinking reactions through activation with UV rays.

It can be of advantage if the polymers are crosslinked not by means of actinic and/or ionizing radiation. In these cases, the crosslinking may be carried out in the absence of UV crosslinkers and/or of electron beam crosslinkers, and so the products obtained also do not have any UV crosslinkers and/or any EBC crosslinkers and/or reaction products thereof.

A polymer foam of the invention displays particularly advantageous properties if the polymer composition surrounding the hollow bodies is homogeneously crosslinked. Although thick layers are not very easily crosslinked homogeneously via the conventional electron beam or UV ray treatment, owing to the rapid decrease in radiation intensity over the depth of penetration, thermal crosslinking nevertheless provides sufficient remedy to this. In the production of particularly thick layers of a polymer foam of the invention, more particularly layers which are more than 150 μm thick, therefore, it is particularly advantageous if the polymer composition to be foamed is equipped with a thermal crosslinker system.

Suitable such crosslinkers, especially for polyacrylates, are isocyanates, more particularly trimerized isocyanates and/or sterically hindered isocyanates free from blocking agent, or epoxide compounds such as epoxide-amine crosslinker systems, in each case in the presence of functional groups in the polymer macromolecules that are able to react with isocyanate groups or epoxide groups, respectively.

In order to attenuate the reactivity of the isocyanates it is possible advantageously to use isocyanates blocked with functional groups that can be eliminated thermally. Preference for the blocking is given to using aliphatic primary and secondary alcohols, phenol derivatives, aliphatic primary and secondary amines, lactams, lactones and malonic esters.

Where epoxide-amine systems are used as crosslinker systems, the amines can be converted into their salts, in order to ensure an increase in the pot life. In that case, volatile organic acids (formic acid, acetic acid) or volatile mineral acids (hydrochloric acid, derivatives of carbonic acid) are preferred for salt formation.

The use of thermal crosslinkers or thermal crosslinker systems is especially advantageous for a polymer foam of the invention because the cavities are a hindrance to the penetration of the layer by actinic radiation. Phase transitions at the cavern shells cause refraction and scattering effects, and so the inner regions of the layer can be reached by the radiation not at all or only in a very much reduced way, with this effect being superimposed, moreover, with the aforementioned effect of an inherently limited depth of penetration. Great advantage therefore attaches to thermal crosslinking for the purpose of obtaining a homogeneously crosslinked polymer matrix.

The foaming of the expandable microballoons takes place at elevated temperatures, and this is at the root of a fundamental problem when thermal crosslinkers are used. The choice of the above-stated, relatively slow-to-react crosslinkers and the choice of the stated crosslinker-accelerator systems for regulating the kinetics of the crosslinking reaction are particularly important for the polymer foams of the invention, since these crosslinkers are capable of withstanding the temperatures that are required for foaming.

Having emerged as particularly preferable for the polymer foam of the invention is a crosslinker-accelerator system which comprises at least one substance containing epoxide groups, as crosslinker, and at least one substance that has an accelerating effect on the linking reaction at a temperature below the melting temperature of the polyacrylate, as accelerator. The system requires that the polymers contain functional groups which are able to enter into crosslinking reactions with epoxide groups. Suitable substances containing epoxide groups include polyfunctional epoxides, more particularly difunctional or trifunctional epoxides (i.e., those having two or three epoxide groups, respectively), and also higher polyfunctional epoxides or mixtures of epoxides with different functionalities. Accelerators that can be used are preferably amines (to be interpreted formally as substitution products of ammonia), examples being primary and/or secondary amines; in particular, tertiary and/or polyfunctional amines may be used. It is also possible to employ substances which have two or more amine groups, in which case these amine groups may be primary and/or secondary and/or tertiary amine groups—more particularly, diamines, triamines and/or tetramines. Amines selected in particular are those which enter into no reactions, or only slight reactions, with the polymer building blocks. Accelerators used may also, for example, be phosphorus-based accelerators, such as phosphines and/or phosphonium compounds.

These systems can be used for the crosslinking, in particular, of polymers based on acrylic esters and/or methacrylic esters, with advantageously at least some of the esters containing the functional groups and/or with comonomers being present that have the functional groups. Suitable functional groups for the polymer to be crosslinked, more particularly for a (meth)acrylate-based polymer, are, in particular, acid groups (for example carboxylic acid, sulfonic acid and/or phosphonic acid groups) and/or hydroxyl groups and/or acid anhydride groups and/or epoxide groups and/or amine groups. It is particularly advantageous if the polymer comprises copolymerized acrylic acid and/or methacrylic acid.

It may, however, also be advantageous to do without accelerants, since accelerants, for example, may tend toward yellowing (particularly nitrogen-containing substances), and this may be disruptive, for example, for transparent polymers or foam compositions for applications in the optical sector. Examples of suitable crosslinkers which manage without addition of accelerant include epoxycyclohexyl derivates, particularly when there are carboxylic acid groups in the polymer to be crosslinked. This may be realized, for example, through at least 5 wt % of copolymerized acrylic acid in the polymer. In the polymer to be crosslinked there are advantageously, in particular, no proton acceptors, no electron-pair donors (Lewis bases) and/or no electron-pair acceptors (Lewis acids). The absence of these substances refers in particular to externally added accelerants, in other words not to accelerants copolymerized or incorporated into the polymer framework; with particular preference, however, there are neither externally added nor copolymerized accelerants present, more particularly no accelerants at all. Having emerged as particularly advantageous crosslinkers are epoxycyclohexylcarboxylates such as (3,4-epoxycyclohexane)methyl 3,4-epoxycyclohexylcarboxylate.

Depending on the field of application and the desired properties of the polymer foam of the invention, further components and/or additives may be added to it, in each case alone or in combination with one or more other additives or components.

A polymer foam of the invention is admixed preferably with adjuvants such as, for example, resins, more particularly tackifier resins and/or thermoplastic resins. Resins for the purposes of this specification are oligomeric and polymeric compounds having a number-average molecular weight Mₙ of not more than 5000 g/mol. The maximum resin fraction is limited by miscibility with the polymers—which have optionally been blended with further substances; at any rate, a homogeneous mixture should be formed between resin and polymers.

Tackifying resins that can be used are the tackifier resins known in principle to the skilled person. Representatives that may be mentioned include the pinene resins, indene resins and rosins, their disproportionated, hydrogenated, polymerized and esterified derivatives and salts, the aliphatic and aromatic hydrocarbon resins, terpene resins and terpene-phenolic resins, and also C5, C9 and other hydrocarbon resins, in each case alone or in combination with one another. With particular advantage it is possible to use all resins that are compatible with the polymer composition, i.e. soluble therein; more particularly, reference may be made to all aliphatic, aromatic and alkylaromatic hydrocarbon resins, hydrocarbon resins based on pure monomers, hydrogenated hydrocarbon resins, functional hydrocarbon resins and natural resins. Preferred terpene-phenolic resins are, for example, Dertophene T105 and Dertophene T110; a preferred hydrogenated rosin derivative is Foral 85.

Further, optionally, it is possible for a polymer foam of the invention to comprise pulverulent and granular fillers, dyes and pigments, including, in particular, those which are abrasive and reinforcing, such as chalks (CaCO₃), titanium dioxides, zinc oxides and/or carbon blacks, for example.

The polymer foam preferably comprises one or more forms of chalk as filler, more preferably Mikrosöhl chalk (from Söhlde). At preferred fractions of up to 20 wt %, the addition of filler produces virtually no change in the technical adhesive properties (shear strength at room temperature, instantaneous bond strength to steel and PE). Likewise with preference it is possible for various organic fillers to be included.

Suitable additives for the polymer foam of the invention, moreover—selected independently of other additives—are non-expandable hollow polymer beads, solid polymer beads, hollow glass beads, solid glass beads, hollow ceramic beads, solid ceramic beads and/or solid carbon beads (“carbon microballoons”).

Additionally it is possible for the polymer foam of the invention to comprise low-flammability fillers, an example being ammonium polyphosphate; electrically conductive fillers, examples being conductive carbon black, carbon fibres and/or silver-coated beads; ferromagnetic additives, examples being iron(III) oxides; aging inhibitors, light stabilizers and/or ozone protectants.

Plasticizers may optionally be included. Examples of plasticizers which can be added include low molecular mass polyacrylates, phthalates, water-soluble plasticizers, plasticizing resins, phosphates or polyphosphates.

The addition of silicas, advantageously of precipitated silica surface-modified with dimethyldichlorosilane, may be utilized in order to adjust the thermal shear strength of the polymer foam.

The invention further provides a method for producing a polymer foam, which comprises the following steps:

a) mixing at least the matrix material of the polymer foam with air;
b) mixing microballoons into the mixture from step a);
c) removing air fractions from the mixture, using a pressure gradient;
d) delivering the mixture;
where step c) takes place after step a) and
step d) takes place after steps a) to c).

The microballoons may therefore be added to an existing matrix material/air mixture, or the matrix material, air and the microballoons are mixed with one another at the same time. Steps a) and b) may therefore take place either at the same time or as a single step or in succession. Step c) may take place after steps a) and b), but also after step a) and before step b).

“Removing air fractions” means that the air is removed not completely but only in a certain fraction from the mixture. More particularly, the amount of air removed is such that the polymer foam contains 2 to 20 vol % of air, based on the total volume of the polymer foam.

The foaming itself may take place as early as after steps a) and b), or alternatively only after the mixture has been delivered. Where unexpanded microballoons and/or microballoons for further expansion are incorporated into the mixture, they may be expanded, in accordance with the invention, at any time after the introduction of the microballoons, i.e. in particular after steps b), c) or d).

In one preferred embodiment of the method of the invention, the polymer foam, after it has been produced, is passed, or shaped, between at least two rotating rolls. With particular preference the polymer foam, after it has been produced, is shaped between two release papers between at least two rolls rotating at the same speed in opposite directions.

### BRIEF DESCRIPTION OF THE DRAWINGS

FIGS. 1 to 4 illustrate methods of foaming polymer compositions in embodiments of the present invention.

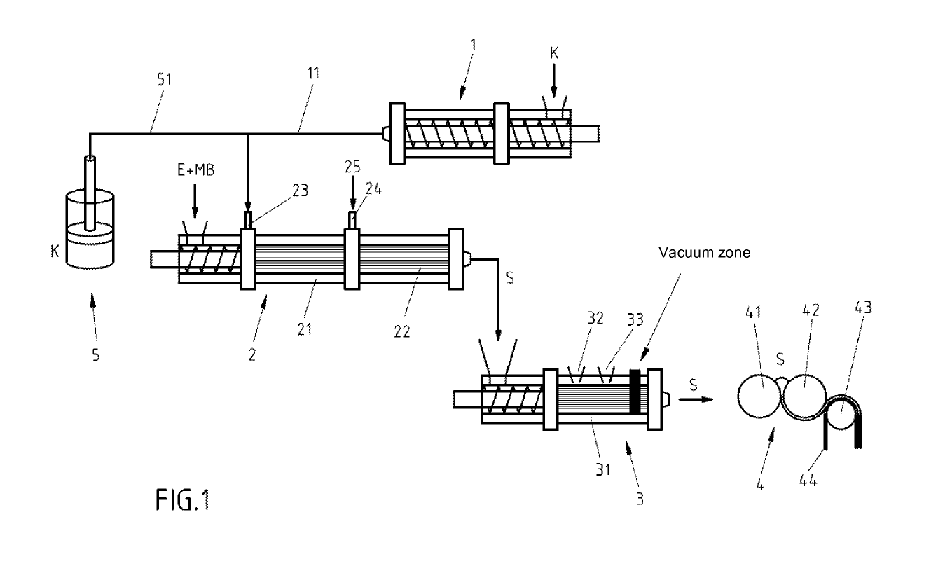

In a method according to FIG. 1, the reactants E, which are to form the matrix that is to be foamed, and the microballoons MB are fed to a continuous mixing assembly 2, for example a planetary roller extruder (PWE). At the same time, in the intake region of the mixing assembly, air is conveyed into the mixing section 21, for example by means of a stuffing screw used in the intake region.

Another possibility, however, is to introduce pre-prepared, solvent-free matrix composition K into the continuous mixing assembly 2 by means of injection 23, through a conveying extruder 1, such as a single-screw extruder (ESE), for example, and a heated hose 11 or through a drum melt 5 and a heated hose 51, and to add the microballoons MB in the intake region or via a side feeder entry in the front region of the mixing assembly. The microballoons may alternatively be injected in a paste under overpressure, for example at the metering point 24.

The microballoons MB are then mixed with the solvent-free composition K or with the reactants E to form a homogeneous composition system in the mixing assembly 2, and this mixture is heated, in the first heating and mixing zone 21 of the mixing assembly 2, to the temperature necessary for the expansion of the microballoons.

In the second injection ring 24, further additives or fillers 25, such as crosslinking promoters, for example, may be added to the mixture.

In order to be able to incorporate thermally sensitive additives or fillers 25, the injection ring 24 and the second heating and mixing zone 22 are preferably cooled.

The foamed composition system S is subsequently transferred to a further continuous mixing assembly 3, for example a twin-screw extruder (DSE), and can then be blended with further fillers or additives, such as crosslinking components and/or catalysts, for example, at moderate temperatures, without destroying the expanded microballoons MB. These components can be added at the metering points 32 and 33. It is advisable to provide the mixing zone of the mixing assembly 3 with a jacket thermal control system 31. Transfer from the first to the second mixing assembly may take place either in free fall or by means of a pipe or hose connection. In this case, a pump has proved to be useful for controlled build-up of pressure.

Before the composition exits from the die, the air that has been incorporated is removed in a controlled way, via the underpressure applied, in a vacuum zone or underpressure zone. Between the last metering point and the vacuum zone, a seal is constructed, by means of kneading elements or a blister, in order to generate a constant underpressure. The foamed composition with the air/microballoon fraction set as desired is predistributed in a die, and the pressure between extruder outlet and die is regulated, here as well, by means of a pump.

With a roll applicator 4, the foamed composition S is calendered and coated onto a web-form carrier material 44, for example onto release paper. There may also be afterfoaming in the roll nip. The roll applicator 4 consists preferably of a doctor roll 41 and a coating roll 42. The release paper 44 is guided to the coating roll 42 via a pick-up roll 43, and so the release paper 44 takes the foamed composition S from the coating roll 42.

In the case of very high layer thicknesses, it is advantageous to shape the composition between two release papers, which are passed via rolls 41 and 42, so that the foamed composition is between these release papers. This procedure improves the coating aesthetics.

In the case of roll calendering, the expanded microballoons MB are pressed back into the polymer matrix of the foamed composition S, thus producing a smooth and, in the case of the foaming of self-adhesives, a permanently (irreversibly) adhesive surface, at very low weights per unit volume of up to 150 kg/m³. Gas bubbles present in the surface of the foam layer, moreover, are integrated back into the matrix again, under the action of the rolls, and uniformly distributed.

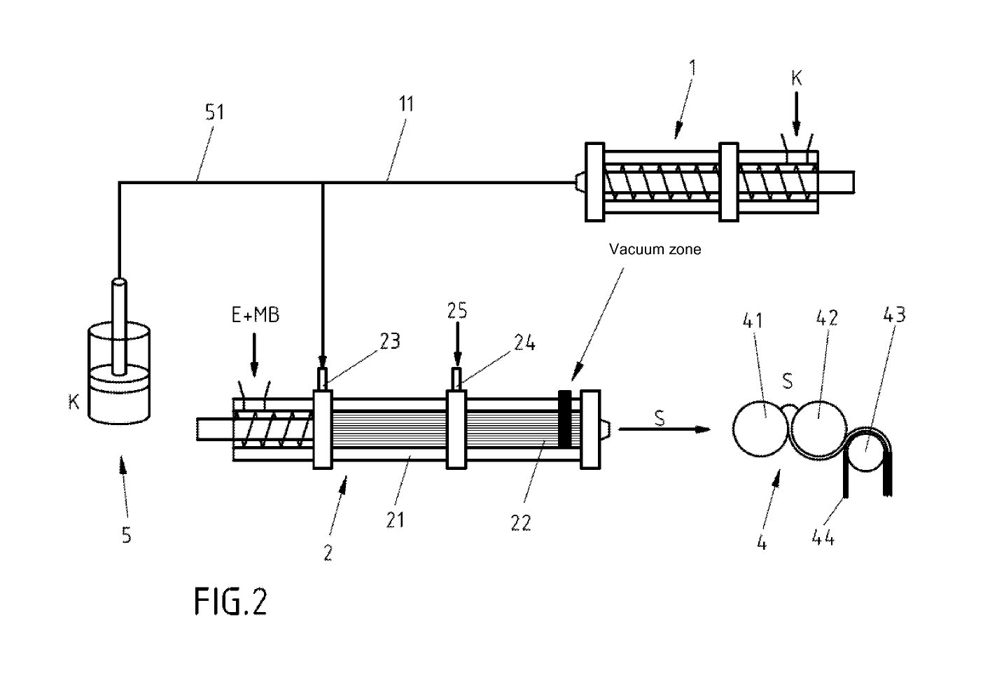

The method of the invention can also be implemented without the second continuous mixing assembly 3. A method regime corresponding to this is shown in FIG. 2, in which the references present are synonymous with those of FIG. 1. Ahead of the die, the incorporated air is removed in a controlled way, via the underpressure applied, in a vacuum zone. Alternatively, via suitable narrowing of the die cross section, the pressure in the die can be adjusted such that the unwanted volume of air is expelled backwards against the flow in a controlled way.

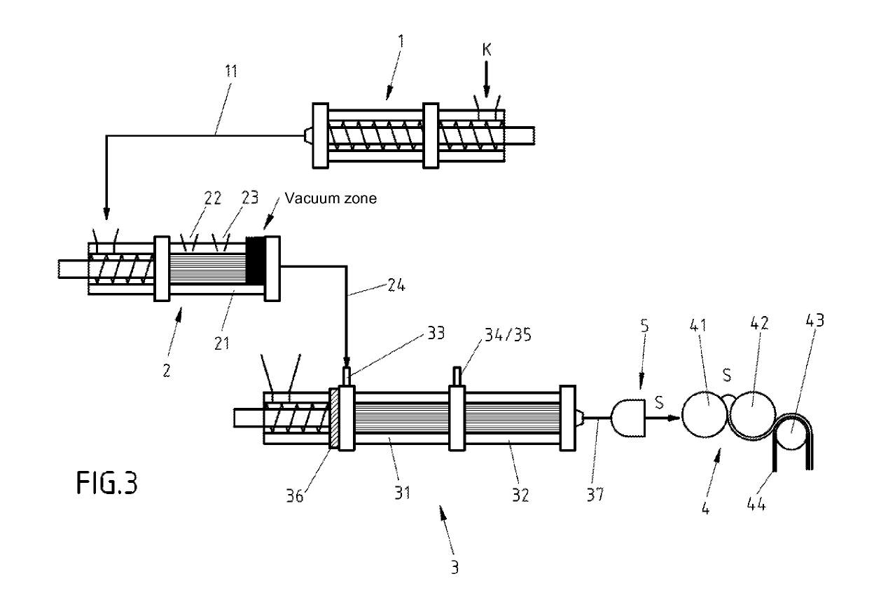

FIG. 3 shows a method in which the microballoons expand only after final blending of the adhesive and after emergence from a die, with a drop in pressure.

The matrix components K are melted in a feeder extruder 1, for example in a single-screw conveying extruder, and the polymer melt is conveyed via a heatable hose 11 or a similar connecting piece into a mixing assembly 2, for example a twin-screw extruder, having a temperature-controllable mixing zone 21. At the same time, with the composition supplied, there is controlled intake of air. The accelerant is then added via the metering aperture 22. Another possibility is to supply additional additives or fillers, such as colour pastes, for example, via further metering points that are present, such as 23, for example.

Before the polymer melt thus blended leaves the mixing assembly 2, its air fraction is adjusted in the vacuum zone. The composition is subsequently conveyed via a heatable hose 24 into a further mixing assembly 3, provided with a sliding sealing ring 36, for example into a planetary roller extruder. The sliding sealing ring serves for the suppression of additional air intake in the mixing assembly 3.

The mixing assembly 3 possesses a plurality of temperature-controllable mixing zones 31, 32 and possesses diverse injection/metering facilities 33, 34, 35, in order for the polymer melt to then be blended with further components. Via the metering point 34, for example, a resin can be added, and a microballoon/crosslinker mixture via 35, and incorporation by compounding can take place in mixing zone 32.

The resulting melt mixture is transferred via a connecting piece or another conveying unit, such as a gear pump 37, for example, into a die 5. After they have left the die, in other words after pressure drop, the incorporated microballoons undergo expansion, producing a foamed self-adhesive S, which is subsequently shaped to a web by means of a roll calender 4. With the method variant according to FIG. 3, the processing of the polymer melt mixture takes place no later than from the addition of the microballoons up to the point of exit from the die, in a controlled way under an overpressure ≧10 bar, in order to prevent premature expansion of the microballoons.

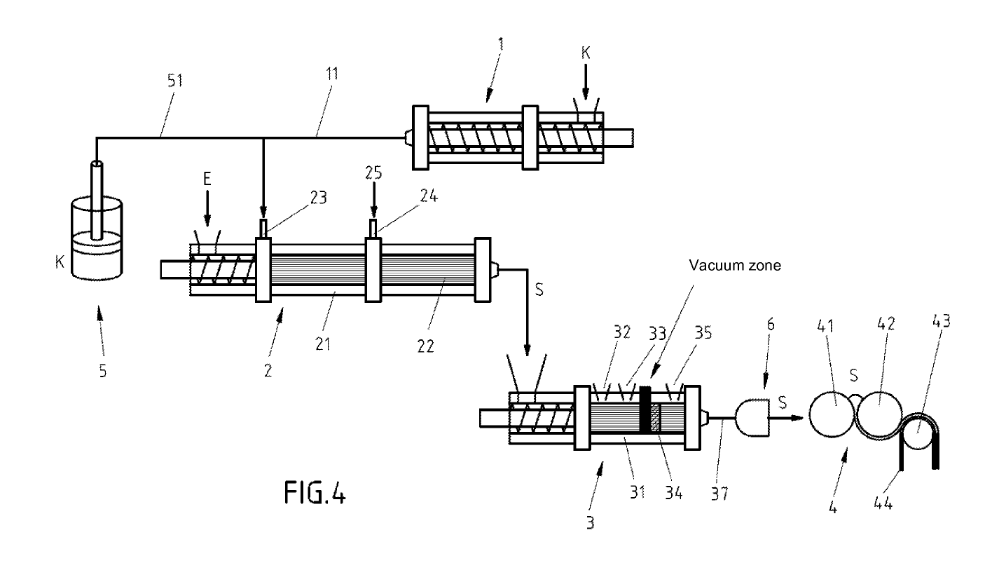

FIG. 4 as well shows a method in which the microballoons undergo expansion only after final blending of the adhesive and after exit from the die, with a pressure drop, and the references present, unless otherwise described, are synonymous with those of FIG. 1.

The matrix components K produced after preparation step 1 are melted in a feeder extruder 1 and conveyed as a polymer melt via a heatable hose 11 or a similar connecting piece into a mixing assembly 2, for example in a planetary roller extruder. Further adjuvants may be introduced into the mixing assembly via the intake region (e.g. solids, such as pellets), via the approach rings 23, 24 (liquid media, pastes, crosslinking systems) or via additional side feeders (solids, pastes, etc.). Air is conveyed into the mixing section 21 by means of a screw in the intake region of the mixing assembly 2.

The machine parameters, such as temperature, rotary speed, etc., of the mixing assembly are selected so as to form a homogeneous mixture S which has a foam-like consistency. Moreover, in a further mixing assembly 3, such as a twin-screw extruder, additives may be added via 32, examples being accelerators, colour pastes, etc. The air fraction in the polymer mixture thus homogenized is then adjusted via regulatable pumps in the vacuum zone. As a result of the installation of a blister (cross sectional narrowing) 34, the mixing assembly is sealed, and so a microballoon paste free of air bubbles can be supplied via a metering point 35 under an opposing pressure >8 bar. The machine parameters of the mixing assembly are selected such that further adjuvants can be incorporated uniformly and so that the microballoons bring about foaming after emergence from the die.

The resulting melt mixture S is transferred to a die 6 via a connecting piece or another conveying unit, such as a gear pump 37, for example.

After they have left the die, in other words after a pressure drop, the incorporated microballoons undergo expansion, thus forming a foamed self-adhesive composition S, which is subsequently shaped in web form by means of a roll calender 4.

In the method variant according to FIG. 4 as well, the polymer melt mixture is processed, after addition of the microballoons paste up to the point of die emergence, in a controlled way under an overpressure ≧8 bar, in order to prevent premature expansion of the microballoons in the extruder.

### EXAMPLES

### Test Methods

Unless indicated otherwise, the tests were carried out under standard conditions, in other words at 23±1° C. and 50±5% relative humidity.

### Density/Weight Per Unit Volume:

### I.1 Density Determination by Pycnometer:

The principle of the measurement is based on the displacement of the liquid located within the pycnometer. First, the empty pycnometer or the liquid-filled pycnometer is weighed, and then the body to be measured is placed into the vessel.

The density of the body is calculated from the differences in weight:

### Let

m₀ be the mass of the empty pycnometer,
m₁ be the mass of the water-filled pycnometer,
m₂ be the mass of the pycnometer with the solid body,
m₃ be the mass of the pycnometer with the solid body, filled up with water,
ρ_{w} be the density of water at the corresponding temperature, and
ρ_{F} be the density of the solid body.

The density of the solid body is then given by:

$${ρ}_{F} = \frac{( {m}_{2} - {m}_{0} )}{( {m}_{1} - {m}_{0} ) - ( {m}_{3} - {m}_{2} )} \cdot {ρ}_{W}$$

A triplicate determination is carried out for each specimen. It should be noted that this method gives the unadjusted density (in the case of porous solid bodies, in the present case a foam, the density based on the volume including the pore spaces).

I.2 Quick Method for Density Determination from the Coatweight and the Film Thickness:

The weight per unit volume or density ρ of a coated self-adhesive is determined via the ratio of the weight per unit area to the respective film thickness:

$$ρ = \frac{m}{V} = \frac{MA}{d} \\ [ ρ ] = \frac{[ kg ]}{[ {m}^{2} ] \cdot [ m ]} = [ \frac{kg}{{m}^{3}} ]$$

MA=coatweight/weight per unit area (excluding liner weight) in [kg/m²]
d=film thickness (excluding liner thickness) in [m]

This method as well gives the unadjusted density.

This density determination is suitable in particular for determining the total density of finished products, including multi-layer products.

### Bond Strength Steel 90°:

The bond strength of the steel is determined under test conditions of 23° C.+/−1° C. temperature and 50%+/−5% relative atmospheric humidity. The specimens are cut to a width of 20 mm and adhered to a sanded steel plate (stainless steel 302 according to ASTM A 666; 50 mm×125 mm×1.1 mm; bright annealed surface; surface roughness 50±25 nm mean arithmetic deviation from the baseline). Prior to the measurement, the steel plate is cleaned and conditioned. For this purpose, the plate is first wiped with acetone and then left to stand in the air for 5 minutes, to allow the solvent to evaporate. After this time, the test specimen is rolled onto the steel substrate. For this purpose, the tape is rolled down five times back and forth with a 2 kg roller, with a rolling speed of 10 m/min. Immediately after roller application, the steel plate is inserted into a special mount of a Zwick tensile testing machine. The adhesive strip is pulled off upward via its free end at an angle of 90° and a rate of 300 mm/min, and the force necessary to achieve this is recorded. The results of measurement are reported in N/cm, and are averaged over three measurements.

### Determining the Volume Fraction of Cavities Enclosed by the Polymer Foam Matrix:

The starting point for this determination is the density of the foamed matrix material (i.e., the matrix material provided with expanded microballoons), excluding incorporated air. First of all, the density of the polymer foam including incorporated air is ascertained. The difference in mass per unit volume is determined from this density via

ρ_{(air fraction 0%)}−ρ_{(air fraction x %)}.

V=m/ρ_{(air fraction 0%)},

where m is the difference in mass as just determined, gives the volume of the polymer foam minus incorporated air, with the incorporated air displaced. If this volume is placed in relation to the volume basis used for the density determination, the result is the volume fraction of the cavities enclosed by the polymer foam matrix.

Analogously, the volume fraction of the cavities formed by the microballoons is determined with the density of the matrix material (without microballoons, without incorporated air) as reference variable.

The intrinsic weight of incorporated air and of the gas-filled microballoons is disregarded when determining the corresponding volume fractions.

### Compressive Strength:

The compressive strength is the compressive stress in N/cm² determined in the course of a defined deformation during loading of the foam.

Test specimens with dimensions of 50×50 mm were cut from the material under test. The cut-to-size specimens were conditioned under test conditions for 24 hours and then placed centrally beneath the pressure plates of a tensile/compression testing machine with compression apparatus. The pressure plates were moved together at a rate of 10 mm/min to such an extent as to expose the sample to a pre-tensioning force of 0.1 kPa. On attainment of this force, the distance of the pressure plates from one another was measured, thus giving the thickness of the test specimen prior to compression.

The test specimen was then compressed four times with a rate of 50 mm/min by the percentage indicated, and allowed to return to the original thickness, with a determination each time of the compressive stress for the required deformation. The values recorded were calculated in N/cm² relative to the initial cross section of the samples, of 2500 mm². Furthermore, the resilience work done by the sample in the first compression sample in each case is determined and is reported as ΔW.

TABLE 1
Raw materials used:

| Chemical compound | Trade name | Manufacturer | CAS No. |
|---|---|---|---|
| Bis(4-tert-butylcyclohexyl) | Perkadox ® | Akzo Nobel | 15520-11-3 |
| peroxydicarbonate | 16 | | |
| 2,2′-Azobis(2-methyl- | Vazo ® 64 | DuPont | 78-67-1 |
| propionitrile), AIBN | | | |
| Pentaerythritol | Polypox ® | UPPC AG | 3126-63-4 |
| tetraglycidyl ether | R16 | | |
| | Denacol ™ | Nagase | |
| | EX-411 | Chemtex Corp. | |
| 3,4-Epoxycyclohexyl- | Uvacure ® | Cytec | 2386-87-0 |
| methyl 3,4-epoxycyclo- | 1500 | Industries | |
| hexanecarboxylate | | Inc. | |
| Triethylenetetramine | Epikure ® | Hexion | 112-24-3 |
| | 925 | Speciality | |
| | | Chemicals | |
| Microballoons (MB) | Expancel | Expancel | |
| | 051 DU 40 | Nobel | |
| | | Industries | |
| Terpene-phenolic | Dertophene | D.R.T. | 73597-48-5 |
| resin | T110 | | |
| Aqueous carbon black | Levanyl | Lanxess | |
| pigment preparation | Schwarz | Deutschland | |
| (40% pigment fraction) | N-LF | GmbH | |
| Cocoalkyl-N,N- | Ethomeen | Akzo | 61791-14-8 |
| polyoxyethylenamine | C/25 | | |
| Paste: Expancel 051 | | | |
| DU 40 41% in Levanyl | | | |
| Schwarz N-LF | | | |
| Paste: Expancel 051 | | | |
| DU 40 55% in Ethomeen | | | |
| C/25 | | | |

### Preparation Step H1 for the Base Polymer K1:

A reactor conventional for radical polymerizations was charged with 54.4 kg of 2-ethylhexyl acrylate, 20.0 kg of methyl acrylate, 5.6 kg of acrylic acid and 53.3 kg of acetone/isopropanol (94:6). After nitrogen gas had been passed through the reactor for 45 minutes with stirring, the reactor was heated to 58° C. and 40 g of AIBN were added. The external heating bath was then heated to 75° C. and the reaction was carried out constantly at this external temperature. After 1 h a further 40 g of AIBN were added, and after 4 h, the batch was diluted with 10 kg of acetone/isopropanol mixture (94:6).

After 5 h and again after 7 h, re-initiation took place, with 120 g of bis(4-tert-butylcyclohexyl) peroxydicarbonate each time. After a reaction time of 22 h, the polymerization was discontinued and the mixture was cooled to room temperature. The polyacrylate obtained has a K value of 58.8, a solids content of 55.9%, an average molecular weight of M_{w}=746 000 g/mol, a polydispersity D (M_{w}/Mₙ) of 8.9 and a static glass transition temperature T_{g} of −35.6° C.

### Preparation Step H2: Concentration of the Hotmelt Pressure-Sensitive Adhesive

The acrylate copolymers (base polymer K1) are very largely freed from the solvent (residual solvent content ≦0.3 wt %; cf. the individual examples) by means of a single-screw extruder (concentrating extruder, Berstorff GmbH, Germany). The concentration parameters are given here as an example. The screw speed was 150 rpm, the motor current 15 A, and a throughput of 58.0 kg liquid/h was realized. For concentration, a vacuum was applied at three different domes. The reduced pressures were, respectively, between 20 mbar and 300 mbar. The exit temperature of the concentrated hotmelt is approximately 115° C. The solids content after this concentration step was 99.8%.

TABLE 2
Compositions of the experimental specimens in the examples

| | | | | According to |
|---|---|---|---|---|
| | Basis | | Fraction of | the preparation |
| Exam- | adhe- | | adjuvants | method as |
| ple | sive K | Adjuvants | [wt %] | per figure |
| 1-5 | K1 | Polypox R16 | 0.1354 | 4 |
| | | Epikure 925 | 0.1414 | |
| | | Expancel 051 DU 40 | 0.70 | |
| | | Dertophene T110 | 28.50 | |
| | | Levanyl schwarz N-LF | 1.00 | |
| 6-10 | K1 | Polypox R16 | 0.1354 | 1 |
| | | Epikure 925 | 0.1414 | |
| | | Expancel 051 DU 40 | 0.70 | |
| | | Dertophene T110 | 28.09 | |
| | | Levanyl N-LF | 0.47 | |

### Development of Bond Strength as a Function of Included Air Fraction:

The self-adhesives of Examples 1-5 were prepared according to the method of the invention as per FIG. 4. The microballoons were therefore metered as a paste with 41% fraction in Levanyl N-LF under an opposing pressure >8 bar. The overpressure of at least 8 bar is maintained until exit from the die, and so the microballoons undergo expansion only after departing from the die. The degassing step upstream of foaming allows air to be removed in a controlled way via a regulatable vacuum pump.

In the case of the experimental specimens of Examples 1-5, the underpressure (1013-100 mbar absolute) applied in each case was different, thus producing graduated air fractions in the adhesive system.

All of the specimens are single-layer adhesive systems which were coated onto a liner. The corresponding test results are shown in Table 3.

TABLE 3
Examples 1-5 - Results

| | | | Example | | | | |
|---|---|---|---|---|---|---|---|
| | | | 1 (CE) | 2 | 3 | 4 | 5 |
| Coatweight | | [g/m²] | 1663 | 1548 | 1475 | 1415 | 1347 |
| Film thickness | | [μm] | 1996 | 1985 | 1980 | 2004 | 1998 |
| Density | | [kg/m³] | 833 | 780 | 745 | 706 | 674 |
| Pressure in the vacuum | | [mbar] | 100 | 250 | 400 | 700 | 1013 |
| zone | | | | | | | |
| Bond | instantaneous | [N/cm] | 17.3 | 18.2 | 20.1 | 15.4 | 18.0 |
| strength | Fracture mode | | adhesive | adhesive | adhesive | adhesive | adhesive |
| 90° | 3 d peel | [N/cm] | 39.5 | 47.2 | 56.5 | 48.7 | 45.5 |
| | increase | | | | | | |
| | Fracture mode | | adhesive | partial | splitting | splitting | splitting |
| | | | | splitting | | | |

| | | | | | | |
|---|---|---|---|---|---|---|
| Air fraction | [vol %] | 0 | 6.4 | 10.6 | 15.2 | 19.1 |

CE = Comparative example

Without included air, as in Example 1, the cohesive force of the adhesive tape is of a magnitude such that the tape, on removal after 3 d peel increase, peels adhesively from the adhesion substrate under investigation.

With air fractions that are still relatively small (Example 2), the adhesive tape already begins to split on removal, and the force measured attains a higher level.

With a fraction of 10.6 vol % air as in Example 3, complete foam splitting is observed, and the bonding strength is increased by 43%.

### Compressive Strength Characteristics as a Function of Included Air Fraction:

The experimental specimens of Examples 6-10 were produced by the method as per FIG. 1. In other words, the microballoons were metered in as solid (powder) and the foaming takes place even before final blending of the polymer composition and before degassing.

In the degassing of polymer that is already foamed, as well as the removal of the air, a portion of highly expanded microballoons are also destroyed. The test results are shown in Table 4.

TABLE 4
Examples 6-10 - Results

| | | | | Pressure in | | | | | | | |
|---|---|---|---|---|---|---|---|---|---|---|---|
| | Coat- | Film | | the vacuum | Air | | F [N/cm²] | | | | |
| | weight | thickness | Density | zone | fraction | | 3% | 7% | 10% | 14% | ΔW |
| Example | [g/m²] | [μm] | [kg/m³] | [mbar] | [vol %] | Cycle | Compression | | | | [J/m²] |
| 6 | 801 | 1169 | 685 | 1013 | 15.6 | 1 | 2.83 | 4.79 | 5.9 | 6.85 | 218.38 |
| | | | | | | 2 | 0.46 | 3.47 | 4.94 | 6.21 | |
| | | | | | | 3 | 0.13 | 3.02 | 4.62 | 5.97 | |
| | | | | | | 4 | 0.04 | 2.73 | 4.41 | 5.79 | |
| 7 | 879 | 1120 | 785 | 750 | 11.2 | 1 | 1.83 | 4.52 | 5.95 | 7.09 | 240.69 |
| | | | | | | 2 | 0.44 | 3.02 | 4.98 | 6.49 | |
| | | | | | | 3 | 0.14 | 2.43 | 4.59 | 6.24 | |
| | | | | | | 4 | 0.01 | 1.99 | 4.36 | 6.06 | |
| 8 | 958 | 1138 | 842 | 600 | 7.3 | 1 | 2.97 | 5.76 | 7.19 | 8.5 | 300.85 |
| | | | | | | 2 | 0.32 | 3.98 | 6.01 | 7.72 | |
| | | | | | | 3 | 0.06 | 3.29 | 5.58 | 7.35 | |
| | | | | | | 4 | 0.01 | 2.82 | 5.3 | 7.21 | |
| 9 | 998 | 1103 | 905 | 400 | 3.9 | 1 | 2.35 | 6.05 | 8.04 | 9.63 | 316.64 |
| | | | | | | 2 | 0.36 | 3.88 | 6.64 | 8.72 | |
| | | | | | | 3 | 0.17 | 2.9 | 6.07 | 8.29 | |
| | | | | | | 4 | 0.07 | 2.15 | 5.72 | 8.05 | |
| 10 (CE) | 1028 | 1109 | 927 | 200 | 0.5 | 1 | 3.45 | 7.25 | 9.59 | 11.36 | 359.5 |
| | | | | | | 2 | 0.22 | 4.7 | 7.83 | 10.15 | |
| | | | | | | 3 | 0 | 3.66 | 7.16 | 9.72 | |
| | | | | | | 4 | 0 | 2.86 | 6.71 | 9.4 | |

A mixture of air bubbles and expanded microballoons has a positive influence on the compressive strength characteristics. The greater the amount of air included, the easier it is to compress the foamed adhesive tape.

With increasing air fraction, moreover, there is a drop in the work done by the sample after compression has taken place, in order to restore the sample thickness to the original value (resilience work ΔW). The resilience as well, therefore, is improved by the included air.

1. A polymer foam comprising cavities formed by microballoons, and 2 to 20 vol. %, based on the total volume of the polymer foam, of the cavities surrounded by the polymer foam matrix.

2. The polymer foam according to claim 1, wherein the polymer foam comprises 6 to 16 vol. % of the cavities surrounded by the polymer foam matrix.

3. The polymer foam according to claim 1, wherein at least 90% of all the cavities surrounded by the polymer foam matrix have a maximum diameter of ≦200 μm.

4. The polymer foam according to claim 1, wherein the polymer foam comprises at least 25 wt %, based on the total weight of the polymer foam, of one or more polymers selected from the group consisting of polyacrylates, natural rubbers and synthetic rubbers.

5. The polymer foam according to claim 1, wherein the polymer foam is a pressure sensitive adhesive.

6. The polymer foam according to claim 1, wherein at least 90% of all the cavities formed by microballoons have a maximum diameter of 10 to 500 μm.

7. A method for producing a polymer foam, comprising the following steps:
a) mixing at least the matrix material of the polymer foam with air;
b) mixing microballoons into the mixture from step a);
c) removing air fractions from the mixture, using a pressure gradient;
d) delivering the mixture,
where step c) takes place after step a) and
step d) takes place after steps a) to c).

8. The method according to claim 7, wherein the polymer foam, after it has been produced, is shaped between at least two rotating rolls.
